(19) United States
(12) Patent Application Publication
(10) Pub. No.: US 2012/0284108 A1
(43) Pub. Date: Nov. 8, 2012

(54) LOYALTY PROGRAM SYSTEMS AND METHODS

(76) Inventors: Ashley Jonathon Fontana, San Francisco, CA (US); Ozan Onay, San Francisco, CA (US); Geoffrey Tabachnick, San Francisco, CA (US)

(21) Appl. No.: 13/157,120

(22) Filed: Jun. 9, 2011

Related U.S. Application Data
(60) Provisional application No. 61/481,738, filed on May 3, 2011.

(51) Int. Cl. G06Q 30/00

(52) U.S. Cl. 705/14.27

(57) ABSTRACT

A method and system manage loyalty program data and rewards. In some embodiments, the method accesses data associated with a social network and identifies an activity associated with the social network performed by a user. The method determines that the identified activity is associated with a loyalty program reward offered by a loyalty program. A reward is associated with the user based on the identified activity being associated with the loyalty program reward.

### RELATED APPLICATION

This application claims the benefit of U.S. Provisional Application No. 61/481,738, entitled “A service that rewards users with loyalty program points for activity on internet-based social networks”, filed May 3, 2011, the disclosure of which is incorporated herein by reference in its entirety.

### TECHNICAL FIELD

The present disclosure generally relates to data processing techniques and, more specifically, to methods and systems to manage data related to loyalty programs.

### BACKGROUND

Loyalty programs are marketing programs that provide incentives or rewards to repeat customers or users. These loyalty programs encourage loyal buying behavior by providing rebates, discounts, reward points, and other incentives to users who make frequent purchases at the associated business. Typical loyalty programs are membership based, where a customer registers personal identification information (e.g., name, address, phone number, and email address) to create an account with the program. Once registered with the loyalty program, the customer may receive marketing offers and earn rewards for specific types of transactions (e.g., product purchases, hotel stays, and airline miles traveled). Example loyalty programs include airline frequent flyer programs, grocery store shopping programs, hotel frequent traveler programs, and the like.

### BRIEF DESCRIPTION OF THE DRAWINGS

Some embodiments are illustrated by way of example and not limitation in the figures of the accompanying drawings.

FIG. 1 is a block diagram depicting an example environment capable of implementing the systems and methods discussed herein.

FIG. 2 is a block diagram of a loyalty program management system, in accordance with some embodiments of the present invention.

FIG. 3 is a flow diagram of a method, in accordance with an embodiment, for registering a user with a loyalty program management system.

FIG. 4 is a flow diagram of a method, in accordance with an embodiment, for authenticating a user account with a social network.

FIG. 5 is a flow diagram of a method, in accordance with an embodiment, for rewarding users based on social network activity.

FIG. 6 is a flow diagram of a method, in accordance with an embodiment, for matching user activities with loyalty rewards.

FIGS. 7A-7E depict, in accordance with an embodiment, various data entries contained in one or more databases.

FIGS. 8-12 depict, in accordance with an embodiment, various display images and user interfaces generated by a loyalty program management system.

FIG. 13 is a block diagram of a machine in the example form of a computer system within which a set of instructions, for causing the machine to perform any one or more of the methodologies discussed herein, may be executed.

### DETAILED DESCRIPTION

Example systems and methods to reward users based on specific activities are described. Specific activities include, for example, social network activities and geographic-based activities that satisfy certain reward criteria. In the following description, for purposes of explanation, numerous specific details are set forth in order to provide a thorough understanding of example embodiments. It will be evident, however, to one skilled in the art that the present invention may be practiced without these specific details.

As used herein, a “social network” is any online (e.g., Internet-based) service or system that allows multiple users to communicate with one another and share information. Example social networks may include a representation of each user of the service (such as a profile web page), a representation of links or relationships between users, methods of communicating between users, and additional services. Facebook, Twitter, and LinkedIn are example social networks.

The loyalty program systems and methods described herein support multiple users and multiple loyalty programs associated with any number of businesses or other entities. As used herein, an “entity” may be a person (e.g., a human), a business (e.g., a company), an organization, a group of people, a persona (e.g., a fictitious character), or any combination thereof. Further, as used herein, a “loyalty program” is any technique, procedure, or program that encourages or rewards behavior or activity associated with one or more users. A loyalty program may also reward a user's behavior or activity associated with one or more entities. For example, a loyalty program may reward behavior in the form of a discount, special offer, rebate, prize, reward points, free products or free services. A loyalty program may also be referred to as a “frequent buyer program”, “customer rewards program”, “customer appreciation program”, “customer satisfaction program” or “customer loyalty program”.

As discussed herein, users are rewarded for certain social network activities and geographic-based activities. Although specific example activities are described for purposes of illustration, alternate embodiments may include any type of social network activity and/or any geographic-based activity. Example social network activities include communicating a message, photo, web site link, geographic check-in or other information to a social network (or communicating through a social network). Example geographic-based activities include communicating a message, photo, geographic check-in or other information that includes an associated geographic location at which the activity occurred.

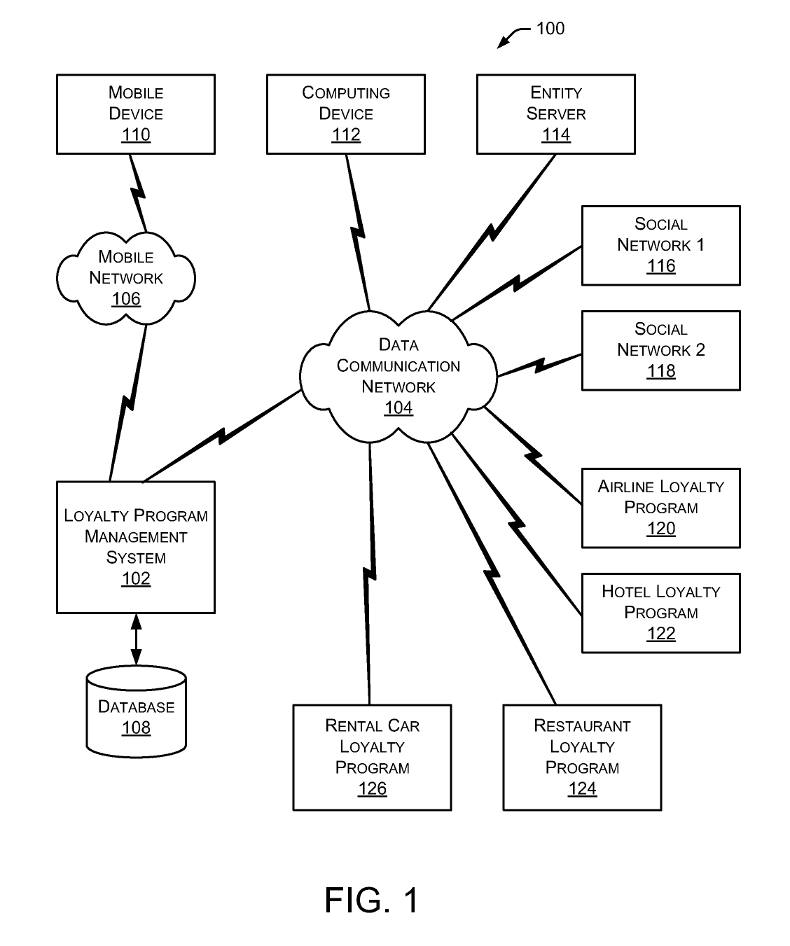

FIG. 1 is a block diagram depicting an example environment 100 capable of implementing the systems and methods discussed herein. A loyalty program management system 102 manages various reward offers and user activities associated with any number of loyalty programs, as discussed herein. Loyalty program management system 102 is coupled to a data communication network 104, a mobile network 106, and a database. Data communication network 104 is capable of communicating data among a variety of devices, such as computing devices, servers, and the like. Data communication network 104 may include a combination of two or more networks communicating data using any communication protocol and any communication medium. In a particular implementation, data communication network 104 includes the Internet.

Mobile network 106 is a communication network configured to communicate signals between loyalty program management system 102 and any number of mobile devices 110. Mobile device 110 includes a cellular phone, portable computing device, and any other device capable of communicating through mobile network 106. In a particular embodiment, mobile network 106 is a cellular network. In alternate embodiments, mobile device 110 may communicate with loyalty program management system 102 via data communication network 104, or via both mobile network 106 and data communication network 104. Database 108 is coupled to loyalty program management system 102 and stores various data, such as user information, reward information, user activities, rewards earned, loyalty program data, reward data reported to loyalty programs, and so forth.

A computing device 112 is also coupled to data communication network 104 and is capable of communicating with loyalty program management system 102. A user may access various systems and services available through data communication network 104 using computing device 112. An entity server 114 is also coupled to data communication network 104. Entity server 114 may contain, for example, loyalty program data or applications for a particular entity. In particular implementations, entity server 114 is a web server that provides access to information associated with an entity's loyalty program.

Data communication network 104 is also coupled to social networks 116 and 118, an airline loyalty program 120, a hotel loyalty program 122, a restaurant loyalty program 124, and a rental car loyalty program 126. Social networks 116 and 118 include any number of social network services that are accessible through the Internet or other data communication networks. Example social networks include Facebook, Twitter (and other microblogging web sites and services), LinkedIn, Foursquare, Gowalla, and Instagram. Although two social networks 116 and 118 are shown in FIG. 1, a particular loyalty program management system 102 may communicate with any number of social networks.

Four loyalty programs 120, 122, 124, and 126 are shown in FIG. 1. In one example, each of the four loyalty programs 120-126 include servers or other computing devices accessible by loyalty program management system 102 through data communication network 104. Although four loyalty programs 120-126 are shown in FIG. 1, a particular loyalty program management system 102 may communicate with and any number of different loyalty programs associated with any type of business in any industry.

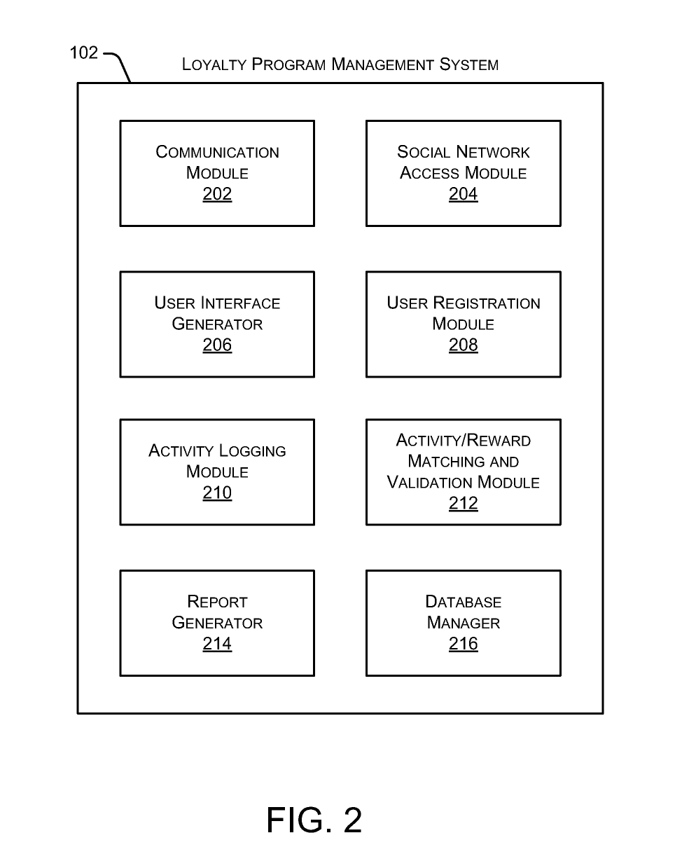

FIG. 2 is a block diagram of loyalty program management system 102, in accordance with some embodiments of the present invention. Loyalty program management system 102 includes a communication module 202 and a social network access module 204. Communication module 202 allows loyalty program management system 102 to communicate with other devices and services, such as the devices, social networks, and loyalty programs shown in FIG. 1. Communication module 202 may support a variety of different communication protocols and communication techniques. Social network access module 204 allows loyalty program management system 102 to access user account information from social networks and to retrieve social network activity data from the social networks.

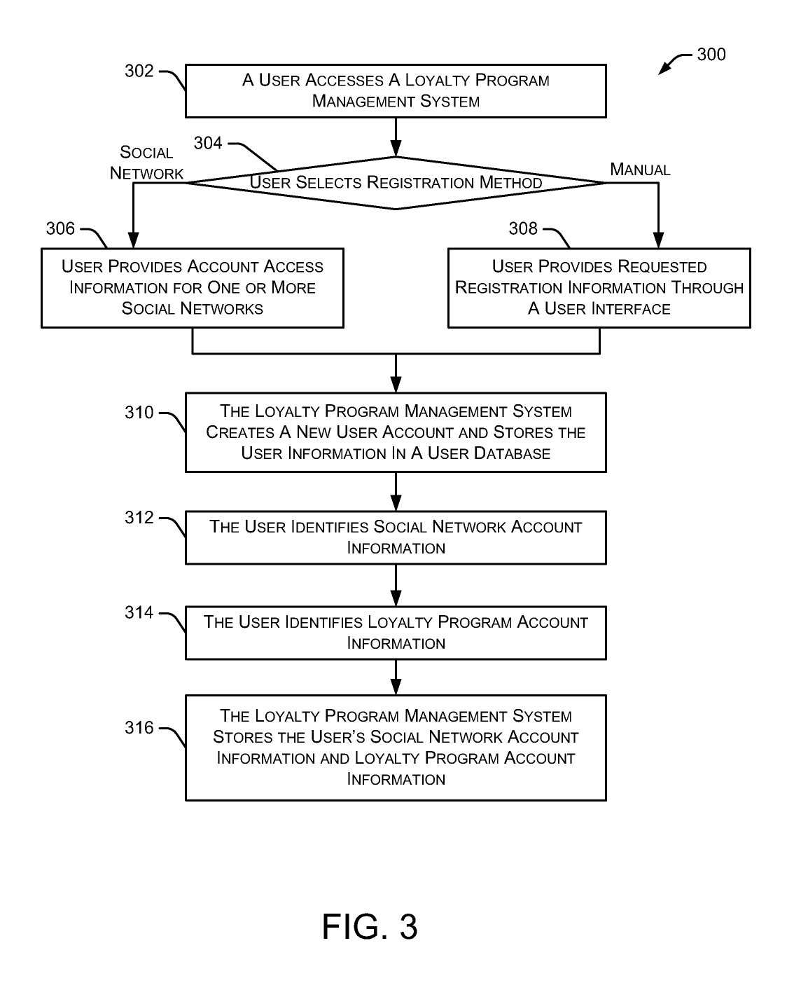

Loyalty program management system 102 also includes a user interface generator 206 and a user registration module 208. User interface generator 206 is capable of generating various user interface components included, for example, in a graphical user interface. User interfaces are generated for mobile devices, computing devices, and any other devices that may interact with loyalty program management system 102. User registration module 208 allows users to register with loyalty program management system 102, which may include identification of a user's social network account information and loyalty program membership information. The user registration process is discussed in greater detail with respect to FIG. 3.

Loyalty program management system 102 further includes an activity logging module 210 and an activity/reward matching and validation module 212. Activity logging module 210 identifies and logs various social network activity. This logged information may include, for example, specific users who performed the social network activity as well as the date, time, and location of the activity. Activity/reward matching and validation module 212 matches specific activities, such as social network activities, with loyalty rewards offered for certain activities. Activity/reward matching and validation module 212 also validates a particular user's eligibility to receive a particular reward.

Loyalty program management system 102 further includes a report generator 214 and a database manager 216. Report manager 214 is capable of generating reports detailing social network activity, rewards earned by particular users, rewards communicated to loyalty programs, and the like. These reports may be communicated, for example, to users, social networks, entity servers, and loyalty programs. Database manager 216 handles the storing of data to database 108 and retrieval of data from database 108. Additionally, database manager 216 may handle the storage and retrieval of data from other databases contained within, or coupled to, loyalty program management system 102. Additional details regarding the operation of loyalty program management system 102, and the components and modules contained within the loyalty program management system, are discussed herein.

FIG. 3 is a flow diagram of a method 300, in accordance with an embodiment, for registering a user with a loyalty program management system. In a particular embodiment, method 300 is implemented by a processor or computing system, such as the processors and computing systems discussed herein. Initially, a user accesses a loyalty program management system at 302. In a particular embodiment, the user access the loyalty program management system through a web site managed by a web server. This web site allows the user to select among multiple registration methods at 304. In the example of FIG. 3, the user can register using social network integration or using manual data entry.

If the user selects registration using social network integration, the user provides account access information (e.g., login name and password) for one or more social networks at 306. In one embodiment, the user may select from multiple social networks with which to register using the social network integration option. In this embodiment, the available social networks are indicated to the user with graphical labels, icons, or other indicators of the available social networks, such as “Register using Facebook” or “Connect with Twitter”.

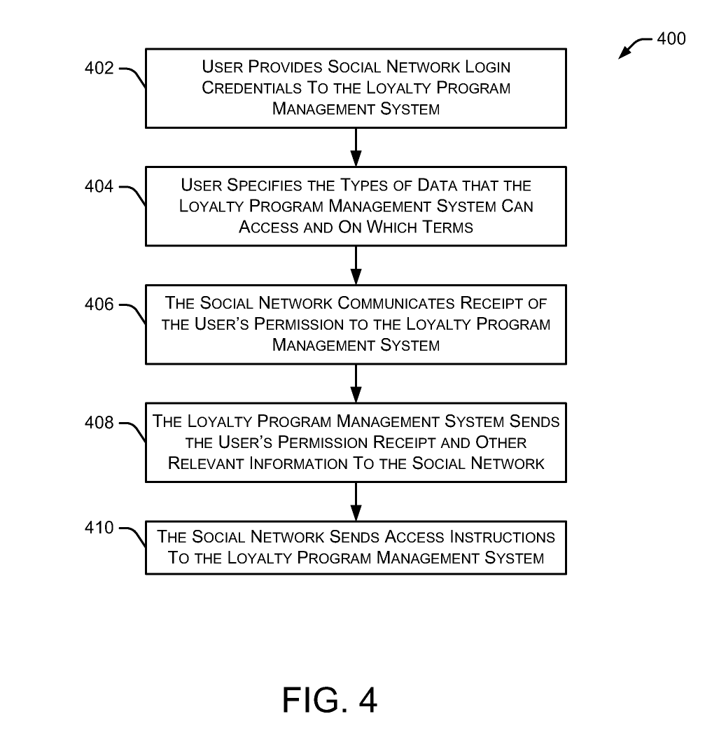

After the user selects a particular social network and provides account access information, method 300 communicates a request to the social network to authenticate the user and receive information about the user from the social network. Additional details regarding this social network authentication are provided herein with respect to FIG. 4.

If, at 304, the user selects registration using manual data entry, the user provides requested registration information through a user interface (e.g., a web form) at 308. In a particular implementation, the registration information includes the user's name, email address, and a password to restrict access to the user's account with the loyalty program management system.

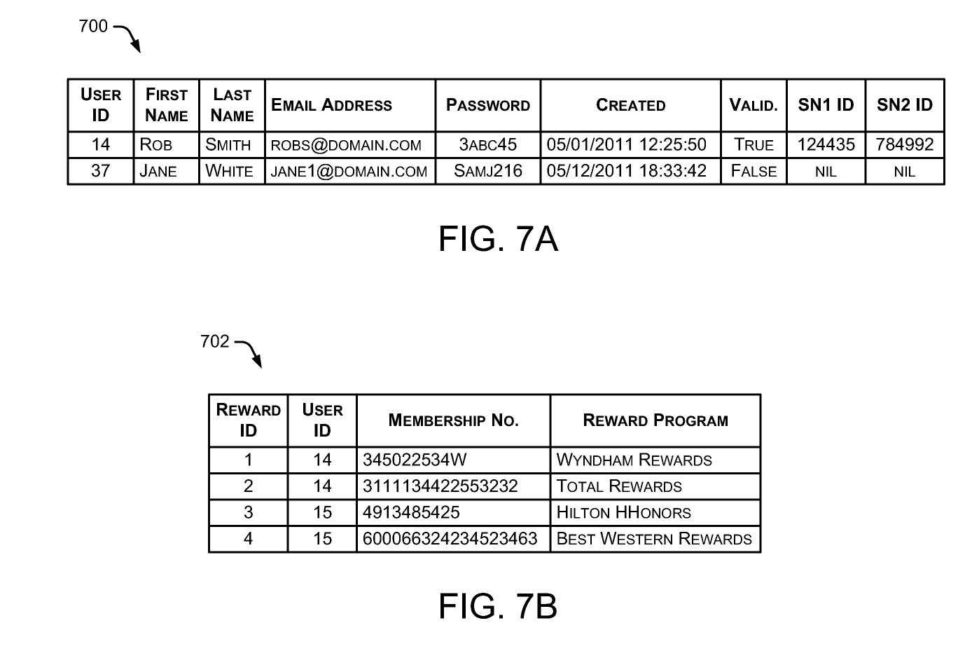

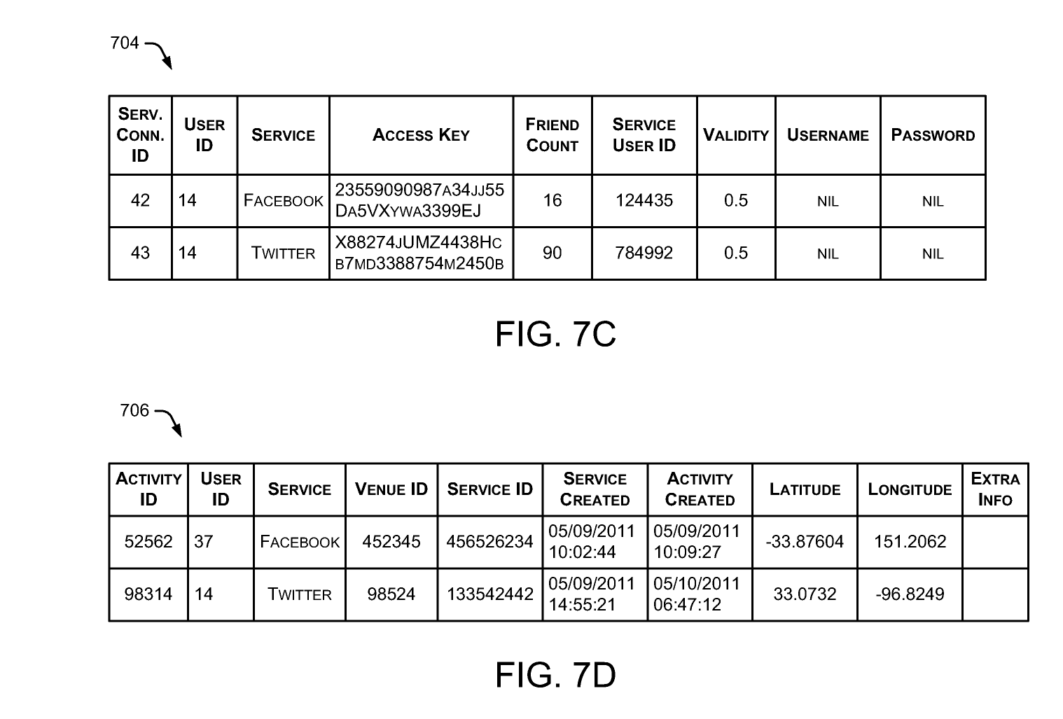

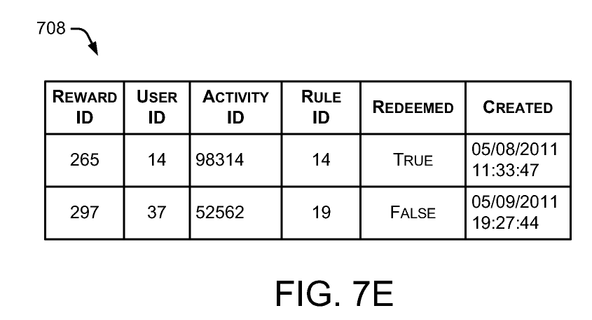

After registering the user, the loyalty program management system creates a new user account and stores the user information in a user database (e.g., database 108) at 310. Example user account database entries are discussed below with respect to FIGS. 7A-7E. After the new user account is created, the user can optionally identify social network account information for additional social networks at 312. For each identified social network account, the loyalty program management system communicates a request to the social network to authenticate the user and receive information about the user from the social network. An example method for performing this social network authentication is shown in FIG. 4. By identifying one or more social network accounts, the loyalty program management system can later access those social network accounts to identify activities by the user that satisfy the requirements for earning specific loyalty rewards.

The user can also optionally identify account information associated with one or more loyalty programs at 314. For example, the user may provide the loyalty program account number (or other identifier) associated with the user's account with the entity or service administering the loyalty program. If the user is a member of multiple loyalty programs, they can provide the loyalty program number for each of the multiple loyalty programs. In one embodiment, the user is presented with a listing of available loyalty programs (e.g., loyalty programs managed or supported by the loyalty program management system) through a user interface. The user selects the loyalty programs in which they have a membership, and enters the loyalty program account number for each selected program.

After receiving social network account information and loyalty program account information, the loyalty program management system stores the user's social network account information and loyalty program account information at 316. This information is stored, for example, in database 108. The social network account information allows the loyalty program management system to later access those social network accounts to identify activities by the user that satisfy the requirements for earning specific loyalty rewards with one or more of the loyalty programs for which the user has provided loyalty program account information.

FIG. 4 is a flow diagram of a method 400, in accordance with an embodiment, for authenticating a user account with a social network. In a particular embodiment, method 400 is implemented by a processor or computing system, such as the processors and computing systems discussed herein. Initially, a user provides social network login credentials to the loyalty program management system at 402. These login credentials can be provided during the user registration process discussed with respect to FIG. 3 or at any other time (e.g., after the user has registered with the loyalty program management system). In a particular implementation, the user is directed to a portion of the social network's web site and asked to provide account login credentials to authenticate the user and allow access to the user's social network account.

Method 400 continues as the user specifies the types of data that the loyalty program management system can access and on which terms at 404. For example, the user may be directed to another portion of the social network web site where the user can elect to make available certain types of data associated with the user's social network account. This elected data is made available for access by the loyalty program management system at future times without requiring repeated authorization by the user. This allows the loyalty program management system to later access data (e.g., user activity data) from the social network that supports the generation of loyalty rewards for the user. The social network data made available by the user may include, for example, the user's name, display picture, gender, social network account number, list of social network connections, and email addresses. The social network data may also include the user's social network account activity, such as social network communications and geolocation check-ins.

In a particular embodiment, the user may specify the terms under which the loyalty program management system can access the user's social network account data. These terms include, for example, whether the loyalty program management system can access the user's social network account data at any time or only when the user is actively using the social network.

After the user authorizes access to the user's social network data by the loyalty program management system, the social network communicates receipt of the user's permission to the loyalty program management system at 406. In response, the loyalty program management system sends the user's permission receipt and other relevant information to the social network at 408. The additional relevant information includes, for example, a unique identifier associated with the loyalty program management system.

Method 400 continues as the social network sends access instructions (e.g., instructions for accessing the user's social network account) to the loyalty program management system at 410. In a particular embodiment, the loyalty program management system stores the received access instructions for future reference. The access instructions include, for example, the user's social network identification number assigned by the social network and used to uniquely identify the user, as well as a unique access token allowing the loyalty program management system to access the user's data, such as the user's social network activities, communications, settings, and other information.

As discussed herein, certain types of social network activity and geographically verified activities are designated as “rewardable activities” or “rewardable activity types”, the execution of which by a user generates a “reward event”. This reward event causes a reward to be generated (or earned) and entered into a database (e.g., a collection of data table entries) for the user. These rewards are allocated a particular number of partner loyalty program points for a specific loyalty program. If the user has provided their loyalty program account information to the loyalty program management system, the loyalty program points are automatically communicated to the loyalty program for crediting to the user's account. If the user has not provided their loyalty program account information, the loyalty program points are maintained by the loyalty program management system for future application to the user's loyalty program account.

Various types of social network activities and geographically verified activities are available for generating reward events. For example, if a user performs a geolocation check-in at a particular location (e.g., a restaurant associated with a particular restaurant loyalty program), the user will receive a reward for that activity. Alternatively, the user may mention a particular company, product or service in a social network communication, which generates a reward for that user. For example, the user may provide a review of the product or service, display a picture of the product, display a picture of the user at a venue (such as a hotel or restaurant), or otherwise promote the company in a social network communication. Additionally, the user may earn loyalty rewards for communicating a link related to a particular product or entity through a social network. In this situation, the user may earn loyalty rewards for communicating (e.g., posting) the link and earn additional loyalty rewards each time another user clicks (or otherwise activates) that link.

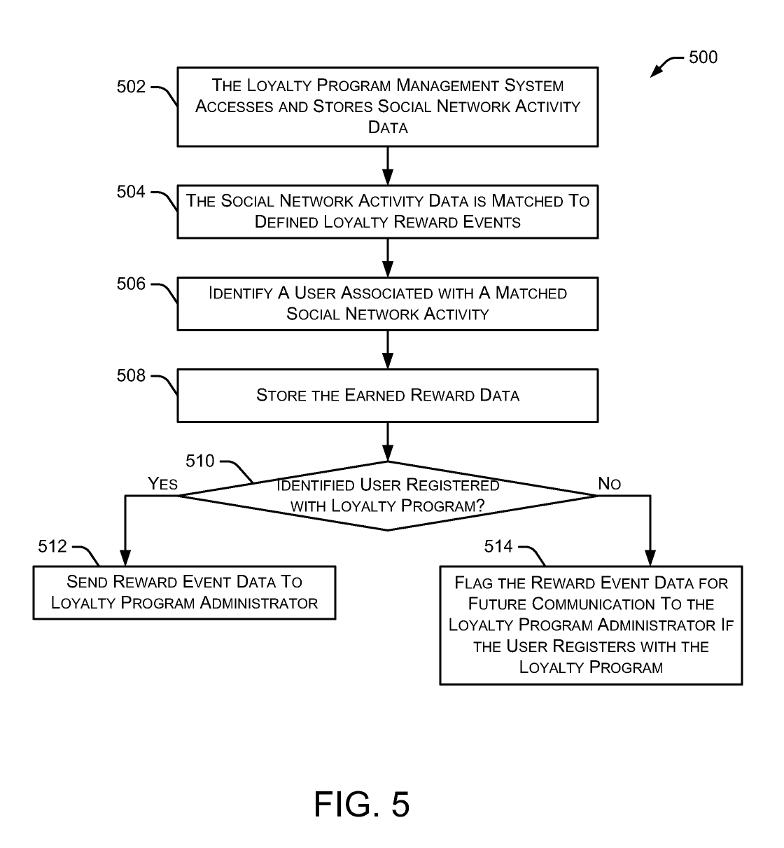

FIG. 5 is a flow diagram of a method 500, in accordance with an embodiment, for rewarding users based on social network activity. In a particular embodiment, method 500 is implemented by a processor or computing system, such as the processors and computing systems discussed herein. Initially, the loyalty program management system accesses and stores social network activity data at 502. In a particular implementation, the loyalty program management system accesses social network activity associated with multiple users registered with the loyalty program management system. The social network activity data associated with the multiple users is stored in a database (e.g., database 108 shown in FIG. 1). Additionally, the loyalty program management system may access multiple different social networks to obtain activity data from each of the multiple social networks. Thus, the loyalty program management system retrieves and stores activity data for multiple users from multiple social networks. This activity data is stored in one or more databases (or other data structures) for access by the loyalty program management system in identifying and awarding loyalty program rewards.

The data accessed by loyalty program management system may be private data accessed based on account access permission provided by the user, as discussed herein. Alternatively, the data accessed by loyalty program management system may be public data available to any user or entity without requiring permission from the user.

The loyalty program management system can access social network activity data using multiple procedures. For example, the loyalty program management system can schedule periodic actions that access the social network activity data on a regular basis (e.g., hourly). This method is referred to as “polling” the social network for each user that has granted permission for the loyalty program management system to access their social network account. Received social network activity data that is already stored in a database (e.g., duplicate data) by the loyalty program management system is discarded. The remaining social network activity data (e.g., the new data that is not already stored in the database) is stored in the database.

In a particular embodiment, the loyalty program management system also determines a geographic location associated with the social network activity. If the geographic location is not already contained in a location database associated with the loyalty program management system, the geographic location is added to that location database. In one implementation, the geographic location is associated with a venue (e.g., a hotel, restaurant, theater or store) based on the geographic coordinates of the location and known coordinates of physical venues. In this implementation, the geographic location can be in the vicinity of the actual venue coordinates (e.g., within a radius of the actual venue coordinates). For example, a user standing across the street from a particular venue may have slightly different geographic coordinates, but still be considered at the venue for purposes of earning loyalty rewards.

In another embodiment, the loyalty program management system accesses social network activity data by initiating a subscription with a social network such that the social network automatically sends a notice of new user activity to the loyalty program management system each time the user's social network account registers new activity. Upon receipt of this notice of new user activity, the loyalty program management system accesses the social network and obtains data associated with the new user activity. This subscription process allows the loyalty program management system to obtain updated user activity data in substantially real time. Particular embodiments may use both of the above-mentioned activity data access procedures (i.e., polling and subscriptions for new user activity).

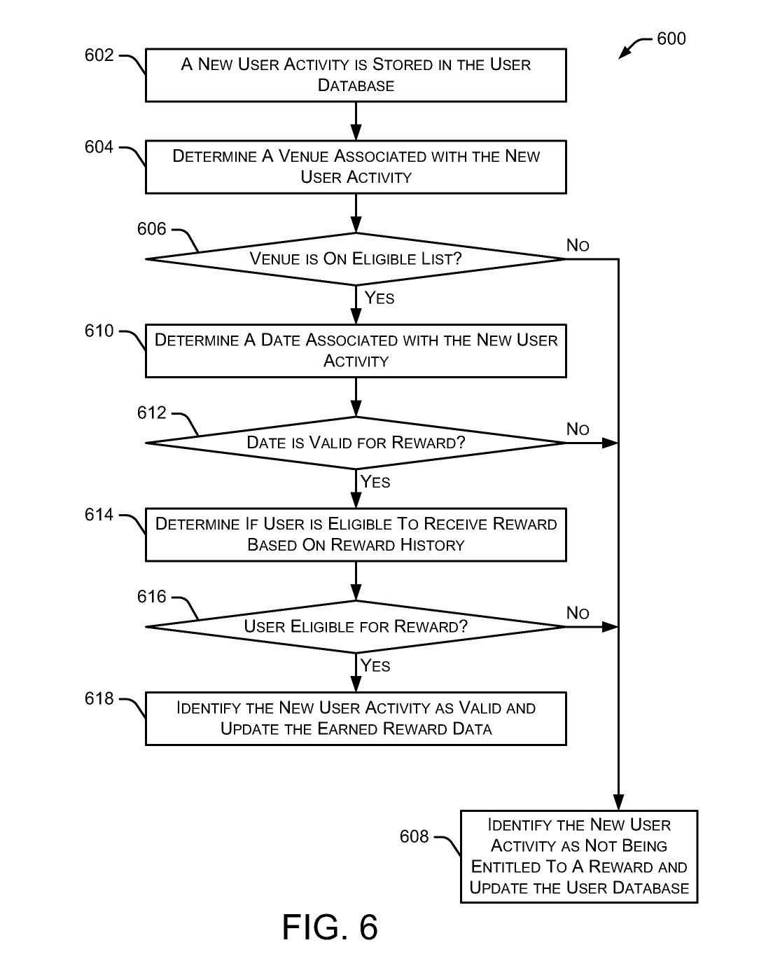

Method 500 continues as the social network activity data is matched to one or more defined loyalty reward events at 504. For example, a hotel loyalty reward event may require that a user generate a social network communication showing a picture of the user at a particular hotel. If a particular user generates such a social network communication, the user's social network activity is considered a “match” to the hotel loyalty reward event. This matching process may also include a validation procedure to ensure that the alleged social network activity is valid and satisfies all requirements of the loyalty reward event. Additional details regarding this matching and validation of social network activity data with loyalty reward events are provided herein with respect to FIG. 6.

After matching social network activity data with loyalty reward events, method 500 identifies a user associated with the social network activity at 506 (e.g., the user who performed the matched social network activity). The matched data, as well as the reward corresponding to the social network activity, is then stored in a log of the user's loyalty reward events at 508. In a particular embodiment, data related to the social network activity and the earned loyalty reward are displayed or otherwise communicated to the user who earned the reward.

Method 500 continues at 510 by determining whether the identified user is registered with the loyalty program for which the loyalty reward was earned. If the user is registered, the method sends the reward event data to a loyalty program administrator or service at 512 to credit the reward to the user's loyalty program account. If the user is not currently registered with the loyalty program, the reward event data is flagged for future communication to the loyalty program administrator or service at 514 in the event that the user later registers with the loyalty program. Thus, a user who is not yet registered with the loyalty program (or who has not notified the loyalty program management system of their loyalty program account number) can still receive the earned loyalty reward at a future time (e.g., when the user registers with the loyalty program or notifies the loyalty program management system of their loyalty program account number).

As discussed above, FIG. 5 illustrates an example method for rewarding users based on social network activity. In alternate embodiments, a similar method is used to reward users based on activity associated with a specific geographic location, regardless of whether the activity is associated with a social network. For example, the geographic location may be associated with a venue such as a store, hotel, restaurant, theater, and the like. Similar procedures are followed to match the user's activity to a loyalty reward event. The procedures further store earned rewards for the user and, if appropriate, communicate the earned rewards to a loyalty program administrator. In these alternate embodiments, the user may communicate their geographic-based activity through any communication mechanism or post their activity to any web site or web-based service. For example, the user may post their activity on a company web site associated with a venue near the location of the geographic-based activity. Further, the user may communicate their activity to a review site, such as a travel review site, a product review site, and the like. Alternatively, the user can communicate their activity in any manner that can be accessed by the loyalty program management system and received by other users.

In one embodiment, the geographic location of a user is determined using a global positioning system (GPS) module contained, for example, in the user's computing device or mobile device. In other embodiments, the geographic location of a user is determined using cellular triangulation, which determines the location of a mobile device based on communication with one or more cellular communication towers. Alternatively, the geographic location of a user is determined by identifying nearby wireless networks and associating that network ID with a known, physical network base station address. The geographic location of the user can be tagged (or otherwise linked) to a user's photo, announcement, review or other communication. Additionally, a venue (e.g., restaurant, hotel, store or theater) located near the user's geographic location is identified based on the geographic information. In a particular embodiment, a web-based service (e.g., foursquare) is used to determine a venue based on the user's geographic location.

FIG. 6 is a flow diagram of a method 600, in accordance with an embodiment, for matching user activities with loyalty rewards. In a particular embodiment, method 600 is implemented by a processor or computing system, such as the processors and computing systems discussed herein. Method 600 is initiated, for example, when a new user activity is stored in the user database at 602. This new user activity may be a social network activity, a geographically verified activity, or other activity that may be entitled to a reward through one or more loyalty reward programs.

In response to the new user activity, method 600 determines a venue associated with the new user activity at 604. The venue can be determined, for example, based on geographic location information associated with the new user activity. At 606, the method determines whether the venue associated with the new user activity is on a list of eligible venues. The list of eligible venues identifies all venues that have active reward offers. If the venue associated with the new user activity is not on the list of eligible venues, the new user activity is identified as not being entitled to a reward at 608 and the database is updated accordingly.

If the venue associated with the new user activity is on the list of eligible venues, method 600 continues by determining a date associated with the new user activity at 610. At 612, the method determines whether the date of the new user activity is valid for one or more rewards. If the new user activity did not occur during a valid period specified by a reward, the new user activity is not entitled to a reward.

If the date associated with the new user activity is within a period specified by a reward, method 600 continues by determining whether the user is eligible to receive a reward based on the user's reward history at 614. Certain rewards limit the number of rewards issued to a user during a particular time period (e.g., day or week). For example, if a user has already received a reward (or multiple rewards) for a similar activity on the same day such that the new activity causes the user to exceed the number of rewards permitted on a particular day (or in a particular time period), the user is not eligible for another reward. If the user is eligible for the reward at 616, method 600 identifies the new user activity as valid and updates the earned reward data log (or similar database) at 618.

In specific embodiments, when determining whether a user is eligible for a reward, method 600 considers the number of connections (e.g., friends) on the social network with which the new user activity is associated. For example, a threshold value of 50 connections may be required for the user to be eligible for a reward. In particular implementations, the user may earn different quantities of reward points based on the number of connections on the social network. For example, the user may earn 50 reward points if they have 50-100 connections, 100 reward points if they have 100-250 connections, 200 reward points if they have 250-500 connections, and so forth.

In a particular embodiment, certain rewards have a random chance of being awarded. Each new user activity is checked to determine whether the random criterion is satisfied. If the random criteria is satisfied for the new user activity, the user receives the reward. Otherwise, the reward is not issued even though the other reward conditions may have been satisfied by the user activity.

In addition to the method discussed with respect to FIG. 6, the loyalty program management system periodically (e.g., daily) reviews user activities stored in the database that did not receive a loyalty reward. Since reward rules and the list of eligible venues changes regularly, the user activities that were not initially eligible for a reward may become eligible based on revisions to reward rules and/or eligible venue information. Thus, users that did not initially receive a loyalty reward may later receive the reward as a result of changes or updates to the reward rules, venues, and so forth.

In some embodiments, the loyalty program management system generates a report of rewards to be assigned to users. This report is provided, for example, to loyalty program administrators. The report may include the user's loyalty membership number, the value of the reward, and the date the reward was credited to the user. When generating the report, the loyalty program management system verifies each loyalty membership number before adding the corresponding entry to the report. This verification includes, for example, applying a validation algorithm to the loyalty membership number and confirming the appropriate number of digits or characters.

FIGS. 7A-7E depict, in accordance with an embodiment, various data entries contained in one or more databases. FIG. 7A depicts a portion of an example user data table 700 contained in a database. Data table 700 includes a user ID that uniquely identifies each user, the user's first name and last name, and the user's email address. Data table 700 also identifies the user's password, a date and time at which the user's account was created and whether the user has been validated (e.g., validating one or more of the user's social network accounts). Data table 700 also identifies the user's ID on one or more social networks. In this example, IDs for two different social networks (SN1 and SN2) are illustrated.

FIG. 7B depicts a portion of an example reward data table 702 contained in a database. Data table 702 includes a reward ID which uniquely identifies each entry in the data table. A user ID indicates a user associated with a particular entry in data table 702. A membership number identifies the user's loyalty program membership number in a particular loyalty reward program (identified in the “reward program” column of data table 702).

FIG. 7C depicts a portion of an example service connection data table 704 contained in a database. Data table 704 includes a service connection ID and a user ID associated with the service connection entry in the data table. Data table 704 also identifies the service (e.g., social network) and an access key for accessing the user's account on the service. A friend count identifies the number of friends (or connections) the user has on the particular service. Data table 704 also includes a service user ID, which identifies the user's ID on the service. A validity entry in data table 704 indicates a likelihood that the access key is valid (e.g., unexpired and not revoked by the user). The validity score may decrease if a significant period of time has passed since the last service access using the access key. If the validity score decreases below a threshold value, the loyalty program management system may request a new access key from the service. Data table 704 may also include a username and password to access the user's account with the service.

FIG. 7D depicts a portion of an example user activity log 706 contained in a database. Activity log 706 includes an activity ID that uniquely identifies each activity (e.g., social network or geographic-based activity that is associated with a reward) and a user ID identifying a user associated with the activity. Activity log 706 also identifies a service associated with the activity, a venue ID associated with the activity, and a service ID. Activity log 706 further indicates a “service created” date and an “activity created” date. The “service created” entry is the date/time when the service (e.g., the social network) created (or recorded) the user activity. The “activity created” entry is the date/time when the loyalty program management system created (or recorded) the user activity. There may be a discrepancy between these two “created” dates/times due to differences in time zones or delays between the occurrence of the activity with the social network and the polling for activities by the loyalty program management system. Activity log 706 also indicates a latitude and longitude associated with the activity. An “extra info” entry is provided for additional information related to the activity, such as a venue name (as identified by the social network) associated with the location, the number of other users at the venue at the time of the activity, whether the user created the venue name or identifier, and whether the venue was recently created.

FIG. 7E depicts a portion of an example reward log 708 contained in a database. Reward log 708 includes a reward ID that uniquely identifies each reward, a user ID associated with the reward, and an activity ID associated with the reward. Reward log 708 also includes a rule ID, a hidden indicator, a redeemed indicator, and a date and time at which the reward was created. The rule ID indicates the rule used to determine whether a particular user activity was eligible for a reward. In a particular implementation, different rules are used for different loyalty programs and different social networks. The “Redeemed” column of reward log 708 indicates whether a particular reward has been redeemed (e.g., sent to the entity managing the loyalty program for credit to the user's loyalty account).

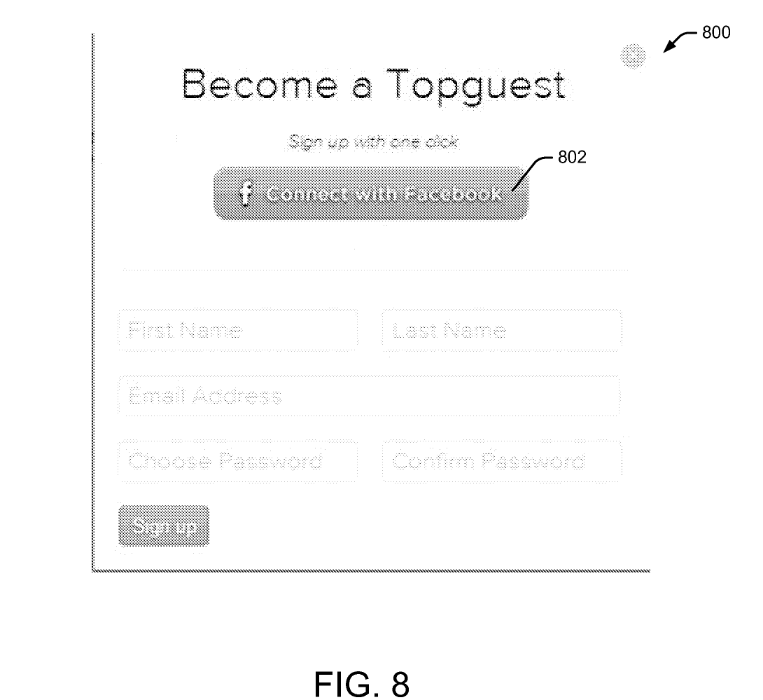

FIGS. 8-12 depict, in accordance with an embodiment, various display images and user interfaces generated by a loyalty program management system. FIG. 8 depicts an example display of a user interface 800 for registering a user with the loyalty program management system. User interface 800 includes a “Connect with Facebook” button 802 that allows a user to register with the loyalty program management system by providing access to their Facebook social network account. Alternatively, the user can register by manually inputting their name, email address and password at the locations indicated in user interface 800.

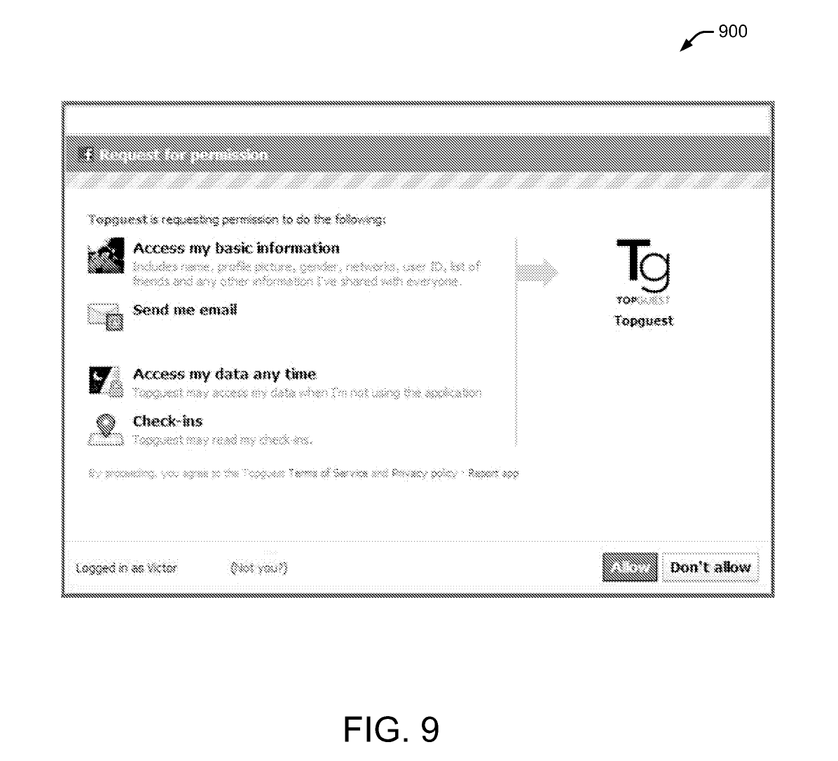

FIG. 9 depicts an example display 900 requesting the user's authorization to access information associated with the user's social network account. In display 900, the user is asked to authorize access to basic account information, receiving email messages, accessing data at any time of day, and accessing check-ins to the social network (e.g., communications indicating the user's current geographic location).

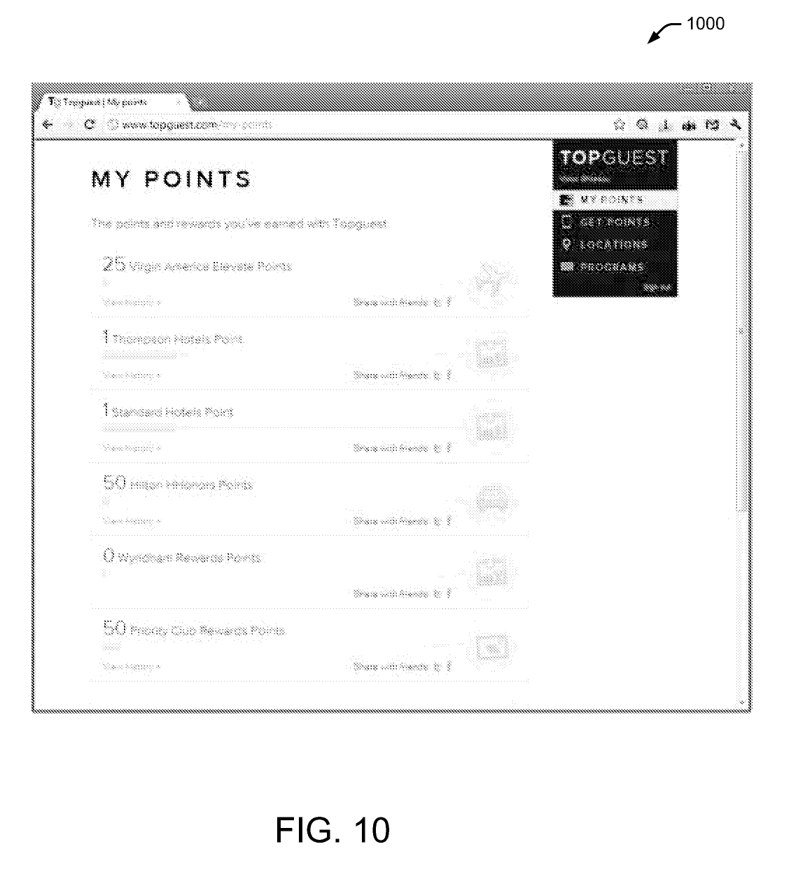

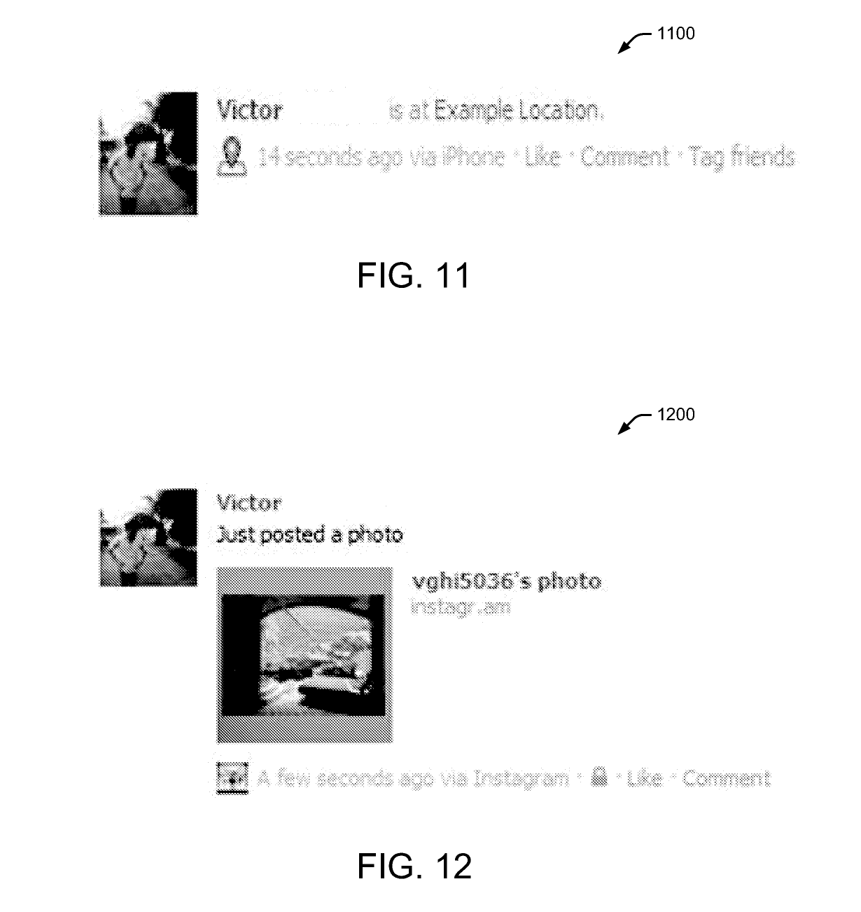

FIG. 10 depicts an example display 1000 of information associated with several user loyalty program accounts. Display 1000 illustrates points earned in various loyalty programs and options to display additional information (e.g., reward point activity history). FIG. 11 depicts an example display 1100 of a social network communication identifying a current user location. This social network communication my earn the user a reward if the location is at or near a particular geographic location (such as a venue) specified in a loyalty reward. FIG. 12 depicts and example display 1200 of a social network communication that includes an attached photo. This social network communication may earn the user a reward if the attached photo is related to a product, service, entity, venue, or other topic associated with a loyalty reward.

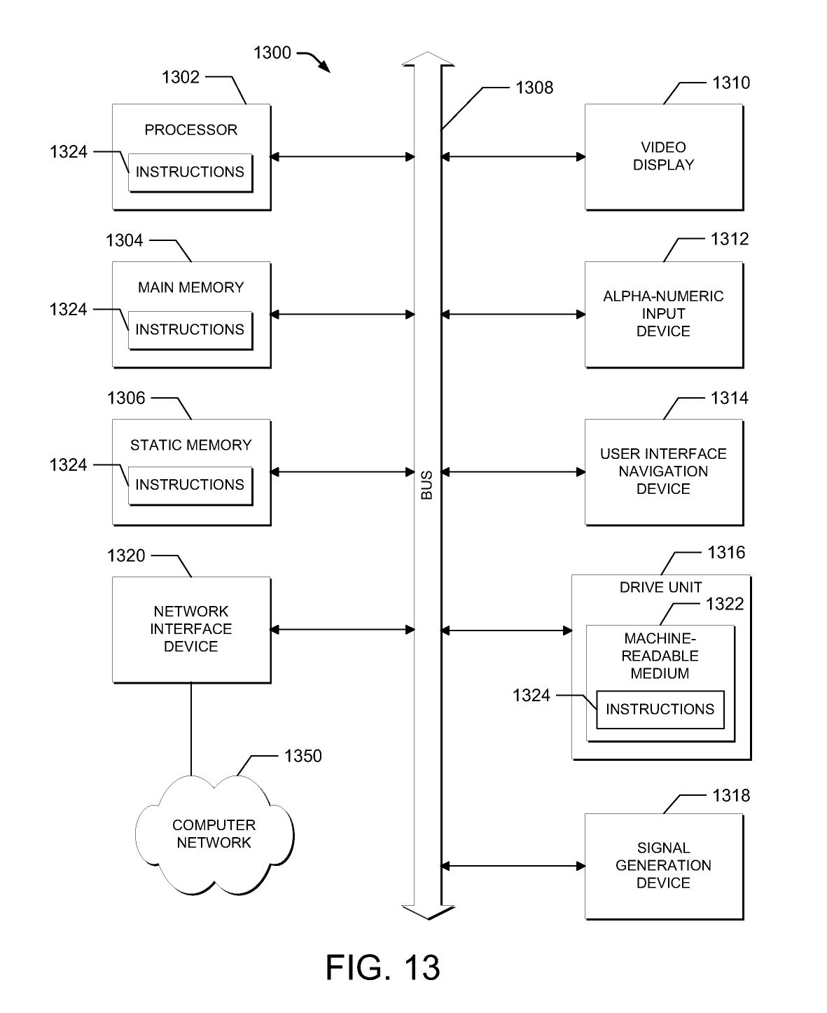

FIG. 13 shows a diagrammatic representation of machine in the example form of a computer system 1300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU) a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a disk drive unit 1316, a signal generation device 1318 (e.g., a speaker) and a network interface device 1320.

The disk drive unit 1316 includes a machine-readable storage medium 1322 on which is stored one or more sets of instructions (e.g., software 1324) embodying any one or more of the methodologies or functions described herein. The software 1324 may also reside, completely or at least partially, within the main memory 1304, within the static memory 1306, and/or within the processor 1302 during execution thereof by the computer system 1300, the main memory 1304 and the processor 1302 also constituting machine-readable media. The software 1324 may further be transmitted or received over a network 1326 via the network interface device 1320.

While the machine-readable storage medium 1322 is shown in an example embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instructions for execution by the machine and that cause the machine to perform any one or more of the methodologies of the present invention. The term “machine-readable storage medium” shall accordingly be taken to include, but not be limited to, solid-state memories, optical and magnetic media, and carrier wave signals.

Thus, a method and system for managing loyalty programs and loyalty rewards have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In the foregoing description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the description, with each claim standing on its own as a separate embodiment.

What is claimed is:

1. A method comprising:
accessing data associated with a social network;
identifying an activity associated with the social network performed by a user;
determining, using one or more processors, that the identified activity is associated with a loyalty program reward offered by a loyalty program; and
associating a reward with the user based on the identified activity being associated with the loyalty program reward.

2. The method of claim 1, further comprising determining that the user is registered with the loyalty program offering the reward.

3. The method of claim 2, further comprising communicating the reward to the loyalty program if the user is registered with the loyalty program offering the reward.

4. The method of claim 1, wherein the activity includes posting a picture to the social network.

5. The method of claim 4, wherein the picture includes an image of the user at a venue associated with the loyalty program.

6. The method of claim 1, wherein the activity includes posting an approximate geographic location of the user to the social network.

7. The method of claim 1, wherein the activity includes posting an identity of a venue proximate a geographic location of the user to the social network.

8. The method of claim 1, wherein the activity includes posting a review of an entity to the social network.

9. The method of claim 1, wherein the activity includes communicating a microblog message via the social network.

10. The method of claim 1, wherein the activity includes communicating a web link via the social network.

11. The method of claim 1, further comprising communicating information associated with the reward to a device associated with the user.

12. The method of claim 1, further comprising:
communicating information associated with the reward to a device associated with the user; and
generating a display image on the device associated with the user, the display image including the information associated with the reward.

13. A method comprising:
identifying a plurality of loyalty program rewards, wherein each of the plurality of loyalty program rewards is associated with a user activity;
identifying an activity performed by a user;
determining a geographic location associated with performance of the activity by the user;
determining, using one or more processors, that the activity performed by the user satisfies the requirements of a loyalty program reward based on the geographic location associated with performance of the activity by the user; and
associating a reward with the user if the activity performed by the user satisfies the requirements of the loyalty program reward.

14. The method of claim 13, wherein identifying the activity performed by the user includes accessing data associated with a social network configured to allow the user to post information regarding the activity and the geographic location associated with performance of the activity.

15. The method of claim 13, wherein the activity includes posting a picture to a social network.

16. The method of claim 13, wherein the activity includes posting a geolocation check-in to a social network.

17. The method of claim 13, wherein the activity includes posting a geolocation check-in to a web site.

18. The method of claim 13, further comprising communicating the reward to a loyalty program associated with the loyalty program reward.

19. A system comprising:
a social network access module configured to access data associated with a social network and identify an activity associated with the social network performed by a user; and
a reward matching module configured to determine that the activity is associated with a loyalty program reward offered by a loyalty program, the reward matching module further configured to associate a reward with the user based on the identified activity being associated with the loyalty program reward.

20. The system of claim 19, wherein the social network access module is further configured to determine a geographic location associated with the activity.
